(19) United States
(12) Patent Application Publication
(10) Pub. No.: US 2025/0249890 A1
(43) Pub. Date: Aug. 7, 2025

(54) PARKING CONTROL DEVICE, METHOD, AND STORAGE MEDIUM

(71) Applicant: TOYOTA JIDOSHA KABUSHIKI KAISHA, Toyota-shi (JP)

(72) Inventors: Takanori Imazu, Anjo-shi (JP); Yohei Suzuki, Handa-shi (JP)

(73) Assignee: TOYOTA JIDOSHA KABUSHIKI KAISHA, Toyota-shi (JP)

(21) Appl. No.: 18/941,124

(22) Filed: Nov. 8, 2024

(30) Foreign Application Priority Data
Feb. 7, 2024 (JP) 2024-017274

(51) Int. Cl. B60W 30/06

(52) U.S. Cl. CPC B60W 30/06; B60W 2554/60

(57) ABSTRACT

A parking control device includes a driving assist ECU for controlling an autonomous driving device to set a target trajectory from a parking start position to a parking completion position in a parking compartment based on information of a target object around the vehicle acquired by the target information acquisition device, and to move the vehicle at least along the target trajectory from the parking start position to the parking completion position by autonomous steering. The driving assist ECU sets the target trajectory so that the wheels of the vehicle do not pass through the parking lock device when it is determined that the parking lock device of the storage blocking type exists in the parking compartment and the parking lock device is unlocked.

### CROSS-REFERENCE TO RELATED APPLICATION

This application claims priority to Japanese Patent Application No. 2024-017274 filed on Feb. 7, 2024, incorporated herein by reference in its entirety.

### BACKGROUND

### 1. Technical Field

The present disclosure relates to a parking control device, a method, and a storage medium for a vehicle such as an automobile.

### 2. Description of Related Art

A parking control device is known as a control device for a vehicle such as an automobile. The parking control device sets a target trajectory from a parking start position to a parking completion position based on information on targets around the vehicle acquired by a target information acquisition device. The parking control device moves the vehicle along the target trajectory by autonomous driving.

For example, Japanese Unexamined Patent Application Publication No. 2018-90108 (JP 2018-90108 A) describes a parking control device that assists parking when there is an obstacle that is a step in a parking route. The parking control device assists parking by a parking route along which the vehicle detours around the obstacle or a parking route along which the vehicle passes over a portion of the obstacle where the inclination angle is smallest based on inclination information of the obstacle.

### SUMMARY

In some parking spaces where vehicles such as automobiles are parked, parking lock devices are installed to prevent the vehicles from entering or leaving the parking spaces. The parking lock device switches between a locked state in which the movement of a vehicle is prevented and an unlocked state in which the movement of the vehicle is permitted, and the form of the parking lock device greatly changes along with the switching. When a leaving prevention parking lock device is in the unlocked state, the wheels of a vehicle are permitted to pass over the parking lock device and move to a parking area. When an entry prevention parking lock device is in the unlocked state, the wheels of a vehicle are not permitted to pass over the parking lock device and move to a parking area.

In the related-art parking control device, the presence or absence of the parking lock device is not determined, and the type and the operation state of the parking lock device are not even determined. Therefore, when the parking of the vehicle is controlled by the parking control device, there is a possibility that the parking lock device and/or the vehicle may be damaged. This possibility is particularly conspicuous when the parking lock device is an entry prevention parking lock device.

Parking of a vehicle may be controlled in a parking space where an entry prevention parking lock device is installed. The present disclosure provides a parking control device, a method, and a storage medium that can reduce the possibility of damage to a parking lock device and/or a vehicle also in this case as compared with the related art.

The present disclosure provides a parking control device (100) including at least:
an autonomous driving device (80) configured to move a vehicle (102) by autonomous steering;
a target information acquisition device (18) configured to acquire information on a target around a vehicle; and
a control unit (driving assist ECU 10) configured to set a target trajectory (150) from a parking start position (102S) to a parking completion position (102C) in a parking area (140) based on the information acquired by the target information acquisition device (S70, S90, S100), and control the autonomous driving device (80) to move the vehicle from the parking start position to the parking completion position along the target trajectory by at least the autonomous steering (S110).

The control unit (driving assist ECU 10) is configured to, when determination is made that an entry prevention parking lock device (110) is present in the parking area and is in an unlocked state based on at least the information acquired by the target information acquisition device (S40, S50), set the target trajectory (150) to cause a wheel (34) of the vehicle not to pass over the entry prevention parking lock device (S70).

The present disclosure provides a parking control method including: setting a target trajectory (150) from a parking start position (102S) to a parking completion position (102C) in a parking area (140) based on information on a target around a vehicle (102) that is acquired by a target information acquisition device (18) (S70, S90, S100); and controlling an autonomous driving device (80) to move the vehicle from the parking start position to the parking completion position along the target trajectory by at least autonomous steering (S110).

The parking control method further includes:

determining whether a parking lock device (110, 120, 130) is present in the parking area based on at least the information acquired by the target information acquisition device (S40, S80); and
setting, when determination is made that an entry prevention parking lock device (110) is present and is in an unlocked state (S40, S50), the target trajectory (150) to cause a wheel (34) of the vehicle not to pass over the entry prevention parking lock device (S70).

The present disclosure provides a storage medium storing a parking control

program that causes an electronic control device (driving assist ECU 10) mounted on a vehicle to:
set a target trajectory (150) from a parking start position (102S) to a parking completion position (102C) in a parking area (140) based on information on a target around the vehicle (102) that is acquired by a target information acquisition device (18) (S70, S90, S100); and control an autonomous driving device (80) to move the vehicle from the parking start position to the parking completion position along the target trajectory by at least autonomous steering (S110).

The parking control program stored in the storage medium further causes the electronic control device to:
determine whether a parking lock device (110, 120, 130) is present in the parking area based on at least the information acquired by the target information acquisition device (S40, S80); and
set, when determination is made that an entry prevention parking lock device (110) is present and is in an unlocked state (S40, S50), the target trajectory (150) to cause a wheel (34) of the vehicle not to pass over the entry prevention parking lock device (S70).

Determination may be made that an entry prevention parking lock device is present in the parking area and is in an unlocked state. In the parking control device, the method, and the storage medium described above, the target trajectory in this case is set to cause the wheel of the vehicle not to pass over the entry prevention parking lock device. Therefore, when the vehicle moves toward the parking completion position along the target trajectory, it is possible to reduce the passage of the wheel of the vehicle over the entry prevention parking lock device in the unlocked state. In addition, it is possible to reduce the possibility of damage to the parking lock device and/or the vehicle due to the passage.

In one aspect of the present disclosure, the control unit (driving assist ECU 10) may be configured to cause the vehicle not to move toward the parking completion position when determination is made that the entry prevention parking lock device is present in the parking area and is in a locked state based on at least the information acquired by the target information acquisition device (S70, S240, S250).

In another aspect of the present disclosure,
the control unit (driving assist ECU 10) may be configured to, when determination is made that a leaving prevention parking lock device is present in the parking area and is in an unlocked state based on at least the information acquired by the target information acquisition device, set the target trajectory to cause at least one wheel of the vehicle to pass over a locking member of the leaving prevention parking lock device (S70).

In the above description, in order to help understanding of the present disclosure, the names and/or the reference signs used in the embodiment are added in parentheses to the configurations of the disclosure corresponding to the embodiment to be described later. However, each component of the present disclosure is not limited to the component of the embodiment corresponding to the name and/or the reference sign attached in parentheses. Other objects, other features and accompanying advantages of the present disclosure will be readily understood from the description of embodiments of the present disclosure described with reference to the following drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a parking control device according to an embodiment;

FIG. 2A is a diagram showing the installation position and operating conditions for various parking locking devices;

FIG. 2B a diagram showing the installation position and operating conditions for various parking locking devices;

FIG. 2C is a schematic diagram showing the installation position and operating conditions for various parking locking devices;

FIG. 2D is a schematic diagram showing the installation position and operating conditions for various parking locking devices;

FIG. 2E is a schematic diagram showing the installation position and operating conditions for various parking locking devices;

FIG. 2F is a schematic diagram showing the installation position and operating conditions for various parking locking devices;

FIG. 2G is a schematic diagram showing the installation position and operating conditions for various parking locking devices;

FIG. 2H is a schematic diagram showing the installation position and operating conditions for various parking locking devices;

FIG. 2I is a schematic diagram showing the installation position and operating conditions for various parking locking devices;

FIG. 3 is a flowchart corresponding to the parking control program in the embodiment;

FIG. 4 is a diagram showing the operation of the embodiment when the parking lock device is in an unlocked state in a parking lock device of a storage blocking type;

FIG. 5 shows the operation of the embodiment when the parking locking device is unlocked in a stowage blocking manner; and

FIG. 6 shows the operation of the embodiment in the absence of a parking lock device.

### DETAILED DESCRIPTION OF EMBODIMENTS

Hereinafter, a parking control device, a method, and a storage medium according to an embodiment of the present disclosure will be described in detail with reference to the accompanying drawings.

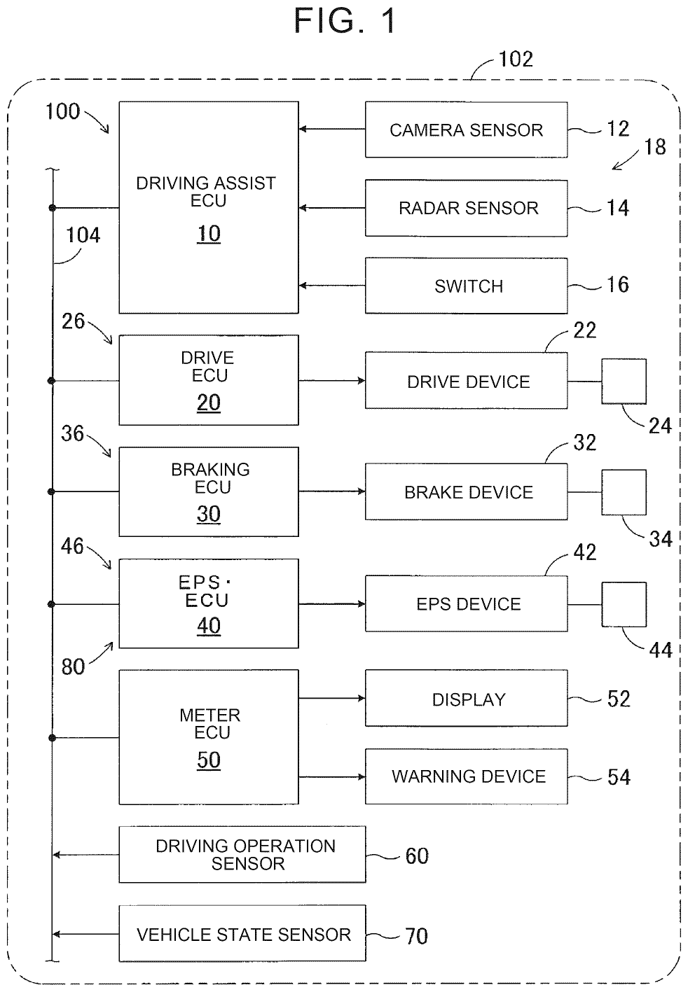

As shown in FIG. 1, a parking control device 100 according to an embodiment of the present disclosure is applied to a vehicle 102 and includes a driving assist ECU 10. The vehicle 102 is a vehicle capable of automated driving, and includes a drive ECU 20, a braking ECU 30, an electric power steering ECU 40, and a meter ECU 50. The ECU means an electronic control unit provided with a microcomputer as its main unit. In the following explanation, the electric power steering is referred to as a EPS.

A microcomputer of each ECU includes a central processing unit (CPU), a read-only memory (ROM), a random access memory (RAM), a readable and writable non-volatile memory (N/M), an interface (I/F), and the like. The CPU realizes various functions by executing instructions (programs, routines) stored in the ROM. Further, these ECUs are connected to each other such that data is exchangeable (communicable) via a controller area network (CAN) 104. Therefore, detected values of sensors (including switches) connected to a specific ECU are transmitted to other ECUs as well.

The driving assist ECU 10 is a central control device that controls driving assistance such as parking control and inter-vehicle distance control. In an embodiment, the driving assist ECU 10 cooperates with other ECU to perform parking control, as will be described further below.

A camera sensor 12, a radar sensor 14, and a switch 16 are connected to the driving assist ECU 10. The camera sensor 12 and radar sensor 14 each include a plurality of camera devices and a plurality of radar devices. The camera sensor 12 and the radar sensor 14 function as a target information acquisition device 18 that acquires target information around the vehicle 102.

Each camera device of the camera sensor 12 includes a camera unit that captures an image of the surroundings of the vehicle 102, and a recognition unit that analyzes image data obtained by capturing an image by the camera unit and recognizes a target such as a white line of a road or another vehicle, although not shown in the drawing. The recognition unit supplies information about the recognized target to the driving assist ECU 10 at predetermined intervals.

Each radar device of the radar sensor 14 detects a distance between the host vehicle and the three-dimensional object, a relative speed between the host vehicle and the three-dimensional object, a relative position (direction) of the three-dimensional object with respect to the host vehicle, and the like by using a millimeter-wave band radio wave. In addition, the radar devices of the radar sensor 14 supply information representing the radar devices to the driving assist ECU 10 at predetermined intervals. Instead of the radar sensor 14 or in addition to the radar sensor 14, light detection and ranging (LiDAR) may be used.

The switch 16 is provided at a position operable by a driver, such as a steering wheel, which is not shown in FIG. 1, and is operable by the driver. The switch 16 includes a parking control switch and a parking start switch. As will be described later, the driving assist ECU 10 executes the parking control when the parking control switch is on, and when the parking start switch is on in a situation where the parking control is being performed, the driving assist ECU 10 starts the control of the moving of the vehicle by autonomous driving.

A drive device 22 that accelerates the vehicle 102 by applying a driving force to the driving wheels 24 is connected to the drive ECU 20. The drive ECU 20 normally controls the drive device 22 such that a driving force generated by the drive device 22 changes in accordance with a driving operation by the driver, and controls the drive device 22 based on a command signal when the drive ECU 20 receives the command signal from the driving assist ECU 10. Thus, the drive ECU 20 and the drive device 22 cooperate with each other to function as the drive control device 26.

A braking device 32 is connected to the braking ECU 30 to decelerate the vehicle 102 by braking by applying a braking force to the wheels 34. The braking ECU 30 controls the braking device so that the braking force generated by the braking device 32 changes in response to a braking operation by the driver in a normal state. In addition, upon receiving the command signal from the driving assist ECU 10, the braking ECU 30 performs the automated braking by controlling the braking device 32 based on the command signal.

Thus, the braking ECU 30 and the braking device 32 cooperate with each other to function as the braking control device 36, and the braking force of the entire vehicle 102 can be controlled, and the braking force of the respective wheels can be individually controlled. When braking force is applied to the wheels by parking control or the like, a brake lamp (not shown in FIG. 1) is turned on.

An EPS device 42 is connected to the EPS-ECU 40. EPS⋅ECU 40 controls EPS device 42 in a manner known in the art based on the steering torque Ts and the vehicle speed V detected by the driving operation sensor 60 and the vehicle state sensor 70 described later. Accordingly, EPS⋅ECU 40 controls the steering assist torque to reduce the steering burden on the driver. Further, EPS⋅ECU 40 can steer the steered wheels 44 as needed by controlling EPS device 42. Thus, EPS⋅ECU 40 and EPS device 42 functions as a steering control device 46 that automatically steers the steered wheels as needed.

The drive control device 26, the braking control device 36, and the steering control device 46 cooperate with the driving assist ECU 10 to function as an autonomous driving device 80 that moves the vehicle 102 by autonomous driving. As will be described later, the driving assist ECU 10 sets a target trajectory from the parking starting position to the parking completion position in the parking compartment based on the information acquired by the target information acquisition device 18. Further, the driving assist ECU 10 controls the autonomous driving device 80 so that the vehicle moves along the target trajectory from the parking starting position to the parking completion position by autonomous driving.

The meter ECU 50 is connected with a touch panel-type display 52 for displaying a state of control by the driving assist ECU 10 and an alarm device 54 for issuing an alarm. The display 52 may be, for example, a multi-information display in which meters and various types of information are displayed, or may be a display of a navigation device. The display 52 may be configured to indicate the status of the parking control upon receiving a signal from the driving assist ECU 10.

The alarm device 54 is activated when it is determined that the vehicle 102 cannot be parked in the parking space desired by the driver, and issues an alarm indicating that the vehicle cannot be parked. The alarm device 54 may be any of an alarm device that issues a visual alarm such as an alarm lamp, an alarm device that emits an auditory alarm such as an alarm buzzer, and an alarm device that issues a bodily alarm such as vibration of a seat, and may be any combination thereof.

The driving operation sensor 60 and the vehicle state sensor 70 are also connected to CAN 104. Information detected by the driving operation sensor 60 and the vehicle state sensor 70 (hereinafter referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a drive operation amount sensor that detects an operation amount of an accelerator pedal, a braking operation amount sensor that detects a master cylinder pressure or a depression force applied to a brake pedal, and a brake switch that detects whether the brake pedal is operated. The driving operation sensor 60 includes a steering angle sensor for detecting a steering angle, a steering torque sensor for detecting a steering torque, and the like.

The vehicle state sensor 70 includes a vehicle speed sensor for detecting a vehicle speed of the vehicle 102, a longitudinal acceleration sensor for detecting an acceleration in the longitudinal direction of the vehicle, a lateral acceleration sensor for detecting an acceleration in the lateral direction of the vehicle, a yaw rate sensor for detecting a yaw rate of the vehicle, and the like.

As described above, in the parking control, a target trajectory from the parking start position to the parking completion position in the parking compartment is set. Whether the setting of the target trajectory and the movement of the vehicle along the target trajectory are performed depends on whether there is a parking lock device in the parking compartment and on the type and operation status of the parking lock device.

### Parking Lock Device

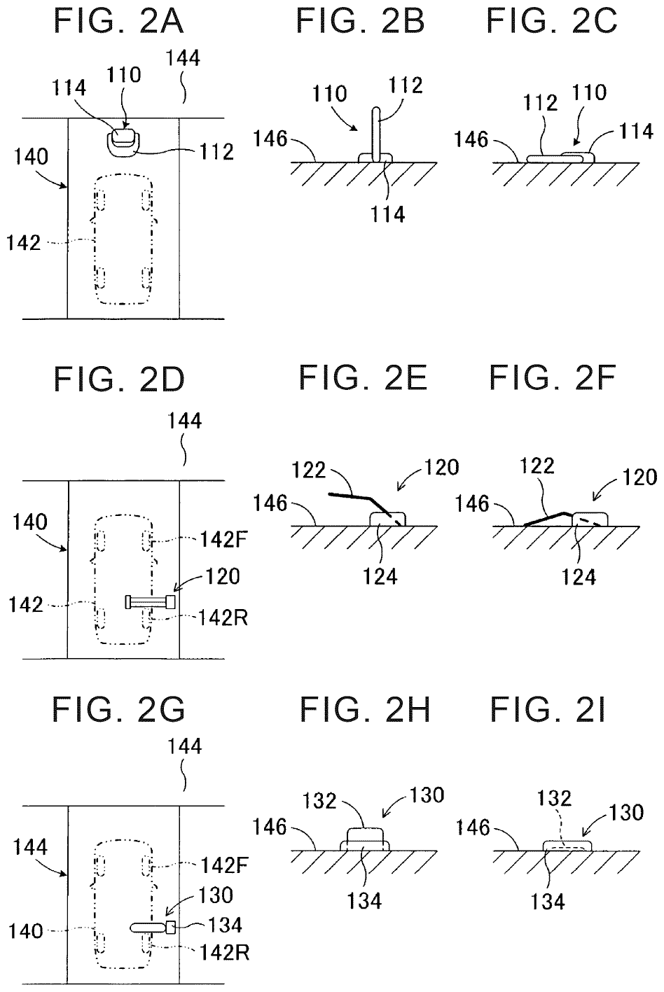

Next, referring to FIGS. 2A, 2B, 2C, 2D, 2E, 2F, 2G, 2H, 2I, a parking locking device installed in a parking compartment will be described. FIGS. 2A, 2B, 2C, 2D, 2E, 2F, 2G, 2H, 2I show the installation position and operating conditions for the various parking locking devices.

In particular, FIG. 2A is a plan view showing a parking area 140 provided with a parking lock device 110 of a storage blocking type. FIG. 2B is a side view of a parking lock device in a locked state; FIG. 2C is a side view of the parking lock device in an unlocked condition.

The parking lock device 110 of the entry blocking type is provided in the center of the parking area 140 at a position closer to the passage 144 so as to be located closer to the passage 144 than the vehicle 142 that has completed parking. The parking lock device 110 includes a lock plate 112 that is substantially arcuate and functions as a lock member, and a drive device 114 that drives the lock plate. When in the locked state, the lock plate 112 stands substantially perpendicular to the surface 146 of the parking area 140 to prevent the vehicle from moving into and entering the parking area 140. On the other hand, when in the unlocked state, the lock plate 112 is inverted so as to be parallel to the surface 146 of the parking area 140, and allows the vehicle to move from the parking area 140 and exit.

The parking lock device 110 is controlled to be in a locked state when parking of the parking area 140 is reserved by a management device (not shown) and is controlled to be in an unlocked state when the vehicle reserved for parking approaches the parking area 140. The switching between the locked state and the unlocked state may be performed by, for example, a user operating the terminal device.

FIG. 2D is a plan view showing a parking compartment pivotal parking locking device of the unloading blocking type is provided. FIG. 2E is a side view of a parking lock device in a locked state; FIG. 2F is a side view of the parking lock device in an unlocked condition.

Pivoting parking lock device 120 of the unloading blocking type is provided on a side portion of parking area 140 at a position far from passage 144 so as to be positioned close to the right rear wheel between the right front wheel 142F and the right rear wheel 142R of vehicle 142 in which parking is completed. The parking lock device 120 includes a rectangular lock plate 122 having a shape of a cross section “to” and functioning as a lock member, and a drive device 124 for driving the rectangular lock plate. When in the locked state, the lock plate 122 pivots such that the trailing edge remote from the passage 144 is raised relative to the leading edge. The lock plate 122 prevents the right rear wheel from moving toward the passage 144, thereby preventing the vehicle 142 from moving out of the parking area 140. On the other hand, when the lock plate 122 is in the unlocked state, the trailing edge portion is at the same height as the leading edge portion, and the vehicle 142 is allowed to move to the parking area 140 to be stored.

The parking lock device 120 is normally controlled to be in an unlocked state so that the vehicle can move to and be stored in the parking area 140. Once the vehicle has moved to the parking area 140 and parking is complete, the lock plate 122 is pivoted by the drive device 124 so that it is locked. Further, the parking lock device 120 is switched from the locked state to the unlocked state by the user operating a control panel (not shown), so that the vehicle can be unlocked.

FIG. 2G is a plan view showing a parking section provided with a lift type parking locking device of an unloading prevention type. FIG. 2H is a side view of a parking lock device in a locked state; FIG. 2I is a side view of the parking lock device in an unlocked condition.

Like the parking lock device 120, the lift type parking lock device 130 of the unloading prevention type is provided on a side portion of the parking area 140 at a position far from the passage 144. As a result, the vehicle is positioned close to the right rear wheel between the right front wheel 142F and the right rear wheel 142R of the vehicle 142 in which parking is completed. The parking lock device 130 includes a lock block 132 having an oval shape and functioning as a lock member, and a drive device 134 for raising and lowering the lock block. When in the locked state, the lock block 132 rises so as to protrude from the surface 146 of the parking area 140, and prevents the right rear wheel from moving toward the passage 144, thereby preventing the vehicle 142 from moving out of the parking area 140. In contrast, when the lock block 132 is in the unlocked state, the top surface of the lock block is substantially flush with the surface 146. The lock block 132 allows the right rear wheel to move to the side of the passage 144, thereby allowing the vehicle 142 to move to the parking area 140 for storage.

The parking lock device 130 is normally controlled to be in an unlocked state so that the vehicle can move to and be stored in the parking area 140. When the vehicle moves to the parking area 140 and parking is completed, the lock block 132 is raised by the drive device 134 so as to be locked. Further, the parking lock device 130 is switched from the locked state to the unlocked state by the user operating a control panel (not shown), so that the vehicle can be unlocked.

In the parking lock devices 120 and 130 of the unloading type, the lock plate 122 and the lock block 132 are formed with high strength, respectively. Therefore, when the vehicle moves to the parking area 140 to be stored, the wheels of the vehicle can pass over the lock plate 122 and the lock block 132. Therefore, the target trajectory for moving the vehicle from the parking start position to the parking completion position in the parking compartment is a target trajectory through which the wheels pass over the lock plate 122 and the lock block 132.

In contrast, in the parking lock device 110 of the storage blocking type, the lock plate 112 is formed of a material such as plastic. Therefore, when the vehicle moves to the parking area 140 to be stored, it is preferable that the wheels of the vehicle do not pass over the lock plate 112. Therefore, the target trajectory for moving the vehicle from the parking start position to the parking completion position in the parking compartment is preferably a target trajectory in which the wheels do not pass over the parking lock device 110.

Further, the parking lock devices 120 and 130 are locked when the vehicle is parked, but are located below the vehicle, so that it is not possible to determine the presence of the parking lock device based on the image captured by the camera sensor 12. On the other hand, when the presence of the parking lock device is determined based on the image captured by the camera sensor 12, the parking lock device is in an unlocked state.

In FIGS. 2D, 2E, 2F and FIGS. 2G, 2H, 2I, the parking lock devices 120 and 130 prevent the right rear wheel from passing through. However, the parking lock device of the unloading blocking type may be such that the lock plate 122 and the lock block 132 extend substantially over the entire width of the parking area 140, respectively, and prevent the passage of both the right and left rear wheels.

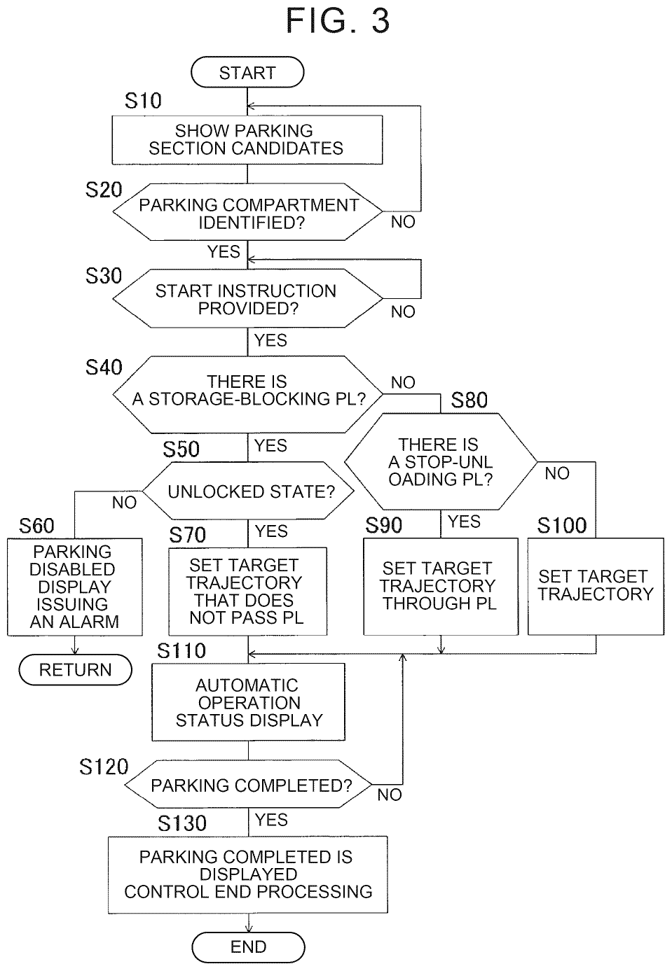

In the embodiment, ROM (storage medium) of the driving assist ECU 10 stores a program of parking control corresponding to the flow chart shown in FIG. 3. The parking control method according to the embodiment is executed by executing the parking control according to the flowchart shown in FIG. 3.

### Parking Control (FIG. 3)

Next, the parking assist control according to the embodiment will be described with reference to the flowchart shown in FIG. 3. The parking assistance control according to the flow chart shown in FIG. 3 is repeatedly executed at predetermined intervals by CPU of the driving assist ECU 10 in a situation where the parking control switch of the switch 16 is on. In the following description, the parking control is referred to as “main control”. Further, in FIG. 3, the parking lock device is denoted as “PL”.

First, in S10, CPU determines whether or not there are candidates for a parking compartment in which the vehicle is parked, that is, a parking compartment in which another vehicle is not parked, within a predetermined range from the vehicle 102, based on the information of the target acquired by the target information acquisition device 18. When an affirmative determination is made, CPU outputs a command to the meter ECU 50. As a result, CPU displays the overhead view images of the vehicle 102 and the surroundings thereof on the display 52 based on the information of the targets acquired by the target information acquisition device 18. As a result, CPU displays the candidates for the parking space.

When a negative determination is made, there is no candidate for a parking compartment, and the display 52 indicates that the vehicle needs to be moved to another position, and the present control may be terminated once.

In S20, CPU determines whether a parking compartment in which the driver desires to park is identified by touching the displayed candidate parking compartment by the driver. When a negative determination is made, the present control returns to S10, and when an affirmative determination is made, the present control proceeds to S30.

In S30, CPU determines whether or not the parking start switch of the switch 16 has been switched on by the driver, that is, whether or not there has been an instruction to start moving the vehicle 102. When a negative determination is made, S30 is repeatedly executed, and when an affirmative determination is made, the present control proceeds to S40. Note that, when the negative determination is performed continuously for the reference number of times or more, the present control may be terminated once.

In S40, CPU determines whether or not there is a parking lock device of a storage blocking type in the specified parking lot, based on information of a target acquired by the target information acquisition device 18, radio communication with a control device of a parking lot, or the like. When a negative determination is made, the present control proceeds to S80, and when an affirmative determination is made, the present control proceeds to S50.

In S50, CPU determines whether or not the parking lock device is unlocked by performing type determination based on, for example, deep neural network (DNN) based on images of the parking lock device of the warehousing blocking type captured by the camera sensor 12. Alternatively, CPU determines whether the parking lock device is unlocked based on the radio communication with the control device of the parking lot. When an affirmative determination is made, that is, when the parking lock device is unlocked and it is determined that the vehicle can be parked, the present control proceeds to S70, and when a negative determination is made, the present control proceeds to S60.

In S60, CPU outputs a command signal to the meter ECU 50 to indicate on the display 52 that the vehicle cannot be parked in the identified parking compartment. Further, CPU outputs a command signal to the meter ECU 50 to activate the alarm device 54, thereby issuing an alarm indicating that the vehicle cannot be parked. When these processes are completed, the present control is terminated once. Note that the issuance of the alarm may be omitted.

In S70, CPU sets a target trajectory for moving the vehicle from the parking starting position (the present position of the vehicle) to the parking completion position in the parking compartment by automated driving. The target trajectory is set so that the wheels 34 of the vehicle 102 do not pass over the parking lock device of the non-locked entry blocking type.

In S80, CPU determines whether or not there is a parking lock device of a

parking lot exit blocking type in the specified parking lot based on the information of the target acquired by the target information acquisition device 18, the radio communication with the managing device of the parking lot, and the like. When a negative determination is made, the present control proceeds to S100, and when an affirmative determination is made, that is, when it is determined that there is a parking lock device of a delivery blocking type and the parking lock device is in an unlocked state, the present control proceeds to S90.

In S90, CPU sets a target trajectory for moving the vehicle from the parking starting position (the present position of the vehicle) to the parking completion position in the parking compartment by automated driving. The target trajectory is set such that the rear wheels 34 of the vehicle 102 pass over the unlocked parking lock device of the unlocked state.

In S100, CPU sets a target trajectory from the parking starting position (the present position of the vehicle) to the parking completion position in the parking compartment. Note that, since the target trajectory in this case is not restricted by the parking lock device, it may be set as a trajectory for moving the vehicle 102 most efficiently from the parking start position to the parking completion position.

In S110, CPU executes autonomous driving by the autonomous driving device 80 so that the vehicle 102 moves along the target trajectory from the parking starting position to the parking completion position. In addition, CPU outputs a command signal to the meter ECU 50 to display an overhead view image of a situation in which the vehicle 102 moves from the parking starting position to the parking completion position on the display 52.

In S120, CPU determines whether or not the vehicle 102 has moved to the parking completion position and is stopped based on whether or not parking has been completed, that is, information on the target acquired by the target information acquisition device 18. When a negative determination is made, the present control returns to S110, and when an affirmative determination is made, the present control proceeds to S130.

In S130, CPU outputs a command to the meter ECU 50 to indicate that parking has been completed on the display 52. Further, CPU performs a control termination process of turning off an ignition switch (not shown) to terminate energization of various devices, and terminates the present control.

### Operation of Embodiments

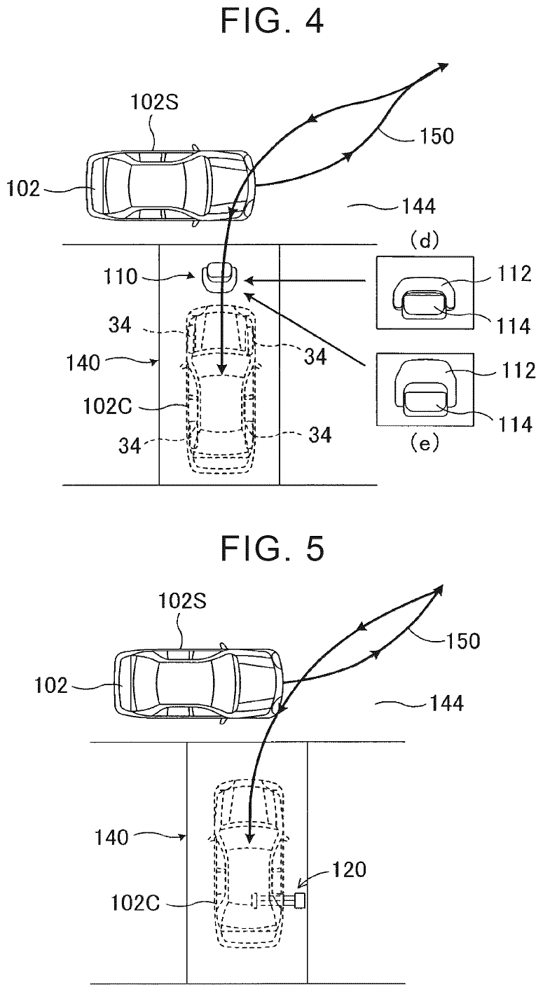

Next, with reference to FIGS. 4 to 6, the operation of the embodiment will be described for various cases in which the types and operating states of the parking lock device are different.

### C1: When Parking Lock Device Is in Unlocked State of Storage Blocking Type (FIG. 4)

When the parking lock device is unlocked by the parking lock device 110 of the storage blocking type, an affirmative determination is made in S40 and S50. In FIG. 4, (d) and (e) each show an example of an image captured by the camera sensor 12 by the parking lock device 110 in the unlocked state and the locked state.

In the unlocked condition, in S70, the target trajectory 150 for moving the vehicle 102 by autonomous driving from the parking starting position 102S to the parking completion position 102C is set so that the wheels 34 of the vehicle do not pass over the parking lock device 110. Further, in S110 and S120, the vehicle 102 is moved along the target trajectory 150 to the parking completion position 102C by autonomous driving, and in S130, the parking is completed. The procedure for moving the vehicle 102 by autonomous driving is the same for C3 and C4 described later.

Accordingly, since the vehicle 102 is moved to the parking completion position 102C by autonomous driving so that the wheels 34 do not pass over the parking lock device 110, it is possible to suppress the parking lock device 110 and/or the vehicle from being damaged.

### C2: When Parking Lock Device Is in Locked Position in Stowage Prevention Type

When the parking lock device 110 is locked (see (e) in FIG. 4), an affirmative determination is made in S40, but a negative determination is made in S50. Therefore, in S60, a message indicating that the vehicle cannot be parked in the specified parking compartment is displayed on the display 52, and an alarm indicating that the vehicle cannot be parked is issued. Therefore, the driver can search for another parking space without parking the vehicle in the specified parking space, and can suppress the parking lock device 110 and the vehicle from being damaged by forcibly parking the vehicle.

### C3: When Parking Lock Device Is Unlocked (FIG. 5)

In such cases, a negative determination and a positive determination are made in S40 and S80, respectively. Therefore, in S90, the target trajectory 150 for moving the vehicle 102 by autonomous driving from the parking starting position 102S to the parking completion position 102C is set so that the rear wheels 34 of the vehicle pass over the parking lock device in the unlocked condition.

Thus, the right wheels 34 of vehicle 102 pass the lock plate 122 or lock block 132 of parking lock device 120 or 130, but parking lock device and vehicle are not damaged.

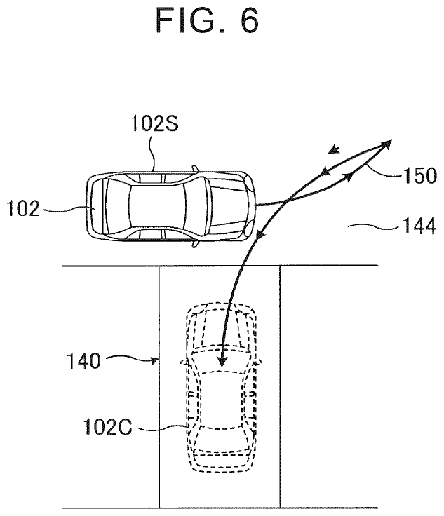

### C4: When There Is No Parking Lock Device (FIG. 6)

In such cases, a negative determination is made in S40 and S80. Therefore, since the target trajectory 150 is not restricted by the parking locking device, it is set as a trajectory for most efficiently moving the vehicle 102 from the parking starting position 102S to the parking completion position 102C in S100.

As can be seen from the above description, according to the present disclosure, it may be determined that the parking lock device 110 of the storage blocking type is present in the parking area 140 and is in an unlocked state. At this time, the target trajectory 150 is set so that the wheels 34 of the vehicle 102 do not pass over the parking lock device of the warehousing blocking type. Therefore, when the vehicle is moved toward the parking completion position 102C along the target trajectory, it is possible to reduce the passage of the wheels of the vehicle on the parking lock device of the entry blocking type in the unlocked condition. In addition, it is possible to reduce the risk of damage to the parking lock device and/or the vehicle due to this.

Further, according to the present disclosure, when it is determined that the parking lock device 110 of the storage blocking type is present in the parking area 140 and is in the locked condition, the vehicle 102 is not moved toward the parking completion position 102C. Therefore, it is possible to avoid collision with the parking lock device of the entry blocking type in which the vehicle is in the locked state and damage to the parking lock device and/or the vehicle due to the collision.

As described above, the parking lock device of the unlocked type is configured to allow the wheels of the vehicle to pass over the locking member of the parking lock device when in the unlocked state. Further, when the parking lock device is a parking lock device of the unloading prevention type, when the vehicle is moved to the parking completion position, the wheel needs to pass over the lock member of the parking lock device.

According to the present disclosure, it may be determined that there is a parking lock device 120 or 130 in the parking area 140 that is stowage blocking and that it is in an unlocked state. At this time, the target trajectory 150 is set so that at least one wheel 34 of the vehicle 102 passes over the locking member 122 or 132 of the parking lock device in the unlocked state. Therefore, it is possible to set a target trajectory passing over the lock member of the parking lock device of the unlocking type in which the wheels of the vehicle are in the unlocked state. Furthermore, a target trajectory can be set in which the parking lock device and/or the vehicle can be moved without being damaged.

In addition, the target trajectory 150 is set to a trajectory that passes over the lock member of the parking lock device of the unlocking type in which the wheels of the vehicle are in the unlocked state. Therefore, when the vehicle is moved to the parking completion position, the wheel passes over the lock member of the parking lock device. Accordingly, when the vehicle completes parking, the parking lock device can transition to the locked state.

The present disclosure has been described in detail above with respect to specific embodiments. However, it is obvious to those skilled in the art that the present disclosure is not limited to the above-described embodiments, and various other embodiments are possible within the scope of the present disclosure.

For example, in the above-described embodiment, when determining whether or not there is a parking lock device in the parking area 140, wireless communication with the management device of the parking lot is also used as necessary. However, when the vehicle and the wireless communication management device are not provided in the parking lot, the determination of the presence or absence of the parking lock device and the determination of the state thereof may be performed based only on the information acquired by the target information acquisition device 18.

Further, in the above-described embodiment, in S110, the autonomous driving by the autonomous driving device 80 is executed so that the vehicle 102 moves along the target trajectory 150 from the parking starting position 102S to the parking completion position 102C. Automatic driving is performed by automatic acceleration, automatic braking, and automatic steering. However, the autonomous driving may be an autonomous driving in which at least one of the autonomous acceleration and the autonomous braking is performed by an operation of the driver.

What is claimed is:

1. A parking control device comprising at least:
an autonomous driving device configured to move a vehicle by autonomous steering;
a target information acquisition device configured to acquire information on a target around a vehicle; and
a control unit configured to set a target trajectory from a parking start position to a parking completion position in a parking area based on the information acquired by the target information acquisition device, and control the autonomous driving device to move the vehicle from the parking start position to the parking completion position along the target trajectory by at least the autonomous steering, wherein
the control unit is configured to, when determination is made that an entry prevention parking lock device is present in the parking area and is in an unlocked state based on at least the information acquired by the target information acquisition device, set the target trajectory to cause a wheel of the vehicle not to pass over the entry prevention parking lock device.

2. The parking control device according to claim 1, wherein the control unit is configured to cause the vehicle not to move toward the parking completion position when determination is made that the entry prevention parking lock device is present in the parking area and is in a locked state based on at least the information acquired by the target information acquisition device.

3. The parking control device according to claim 1, wherein the control unit is configured to, when determination is made that a leaving prevention parking lock device is present in the parking area and is in an unlocked state based on at least the information acquired by the target information acquisition device, set the target trajectory to cause at least one wheel of the vehicle to pass over a locking member of the leaving prevention parking lock device.

4. A parking control method comprising:
setting a target trajectory from a parking start position to a parking completion position in a parking area based on information on a target around a vehicle that is acquired by a target information acquisition device; and
controlling an autonomous driving device to move the vehicle from the parking start position to the parking completion position along the target trajectory by at least autonomous steering, the parking control method further comprising:
determining whether a parking lock device is present in the parking area based on at least the information acquired by the target information acquisition device; and
setting, when determination is made that an entry prevention parking lock device is present and is in an unlocked state, the target trajectory to cause a wheel of the vehicle not to pass over the entry prevention parking lock device.

5. A non-transitory storage medium storing a parking control program that causes an electronic control device mounted on a vehicle to:
set a target trajectory from a parking start position to a parking completion position in a parking area based on information on a target around the vehicle that is acquired by a target information acquisition device; and
control an autonomous driving device to move the vehicle from the parking start position to the parking completion position along the target trajectory by at least autonomous steering, the parking control program further causing the electronic control device to:
determine whether a parking lock device is present in the parking area based on at least the information acquired by the target information acquisition device; and
set, when determination is made that an entry prevention parking lock device is present and is in an unlocked state, the target trajectory to cause a wheel of the vehicle not to pass over the entry prevention parking lock device.
